(19) United States
(12) Patent Application Publication
(10) Pub. No.: US 2023/0155117 A1
(43) Pub. Date: May 18, 2023

(54) NONAQUEOUS ELECTROLYTE ENERGY STORAGE DEVICE AND ENERGY STORAGE APPARATUS

(71) Applicant: GS Yuasa International Ltd., Kyoto-shi, Kyoto (JP)

(72) Inventors: Hiromasa Muramatsu, Kyoto (JP); Heisuke Nishikawa, Kyoto (JP)

(21) Appl. No.: 17/916,944

(22) PCT Filed: Mar. 23, 2021
(86) PCT No.: PCT/JP2021/011882

§ 371 Date: Oct. 4, 2022

(30) Foreign Application Priority Data
Apr. 8, 2020 (JP) 2020-070028

(51) Int. Cl. H01M 4/38; H01M 4/66

(52) U.S. Cl. CPC H01M 4/382; H01M 4/661; H01M 2004/027

(57) ABSTRACT

One aspect of the present invention is a nonaqueous electrolyte energy storage device including: a negative electrode containing a lithium alloy containing gold, and lithium metal; a positive electrode; and a nonaqueous electrolyte, in which the negative electrode includes a negative electrode substrate including a metal foil and a coating layer coating the negative electrode substrate, the metal foil contains copper, nickel, or stainless steel as a main component, and the coating layer contains gold as a main component.

### TECHNICAL FIELD

The present invention relates to a nonaqueous electrolyte energy storage device and an energy storage apparatus.

### BACKGROUND ART

Nonaqueous electrolyte secondary batteries typified by lithium ion secondary batteries are widely used for electronic devices such as personal computers and communication terminals, motor vehicles, and the like since these secondary batteries have a high energy density. The nonaqueous electrolyte secondary batteries generally include a pair of electrodes, which are electrically separated from each other by a separator, and a nonaqueous electrolyte interposed between the electrodes, and are configured to allow ions to be transferred between the two electrodes for charge-discharge. Capacitors such as lithium ion capacitors and electric double-layer capacitors are also widely used as nonaqueous electrolyte energy storage devices other than nonaqueous electrolyte secondary batteries.

In recent years, in order to increase the capacity of nonaqueous electrolyte secondary batteries, it has been required to increase the capacity of the negative electrode. Lithium metal has a significantly larger discharge capacity per active material mass than graphite, which is currently widely used as a negative active material for lithium ion secondary batteries. That is, the theoretical capacity per mass of graphite is 372 mAh/g, but the theoretical capacity per mass of lithium metal is 3860 mAh/g, which is significantly large. Therefore, a nonaqueous electrolyte secondary battery containing lithium metal as a negative active material has been proposed (see JP-A-2011-124154).

### PRIOR ART DOCUMENTS

### Patent Document

Patent Document 1: JP-A-2011-124154

### SUMMARY OF THE INVENTION

### Problems to be Solved by the Invention

However, in a nonaqueous electrolyte energy storage device in which a negative electrode contains lithium metal, lithium metal may be deposited in a dendritic form at the surface of the negative electrode during charge (hereinafter, lithium metal in a dendritic form is referred to as a “dendrite”). This dendrite is likely to be electrically isolated due to dissolution of lithium metal on the surface of the negative electrode at the time of subsequent discharge, and thus the coulombic efficiency of the nonaqueous electrolyte energy storage device may be lowered.

The present invention has been made in view of the circumstances as described above, and an object thereof is to provide a nonaqueous electrolyte energy storage device and an energy storage apparatus capable of improving the coulombic efficiency when the negative electrode includes the lithium metal.

### Means for Solving the Problems

One aspect of the present invention is a nonaqueous electrolyte energy storage device including; a negative electrode containing a lithium alloy containing gold, and lithium metal; a positive electrode; and a nonaqueous electrolyte, in which the negative electrode includes a negative electrode substrate including a metal foil and a coating layer coating the negative electrode substrate, the metal foil contains copper, nickel, or stainless steel as a main component, and the coating layer contains gold as a main component.

Another aspect of the present invention is an energy storage apparatus including two or more nonaqueous electrolyte energy storage devices, and one or more nonaqueous electrolyte energy storage devices according to one aspect of the present invention.

### Advantages of the Invention

According to the nonaqueous electrolyte energy storage device and the energy storage apparatus according to one aspect of the present invention, coulombic efficiency can be improved when the negative electrode contains lithium metal.

### BRIEF DESCRIPTION OF THE DRAWINGS

FIG. 1 is a perspective view illustrating a nonaqueous electrolyte energy storage device according to an embodiment of the present invention.

FIG. 2 is a schematic view illustrating an energy storage apparatus configured by assembling a plurality of the nonaqueous electrolyte energy storage devices according to an embodiment of the present invention.

FIG. 3 is an X-ray diffraction diagram after initial charge in Examples and Comparative Examples.

FIG. 4 is an image obtained by scanning electron microscope observation of a surface of a negative electrode after initial charge in Example.

FIG. 5 is an image obtained by scanning electron microscope observation of a surface of a negative electrode after initial charge in Comparative Example.

### MODE FOR CARRYING OUT THE INVENTION

First, an outline of a nonaqueous electrolyte energy storage device disclosed in the present specification will be described.

A nonaqueous electrolyte energy storage device according to one aspect of the present invention includes: a negative electrode containing a lithium alloy containing gold, and lithium metal; a positive electrode; and a nonaqueous electrolyte, in which the negative electrode includes a negative electrode substrate including a metal foil and a coating layer coating the negative electrode substrate, the metal foil contains copper, nickel, or stainless steel as a main component, and the coating layer contains gold as a main component.

In the nonaqueous electrolyte energy storage device, coulombic efficiency can be improved even when the negative electrode contains lithium metal. Although the reason therefor is not clear, the following reason is presumed. In general, when lithium metal is contained in the negative electrode of the nonaqueous electrolyte energy storage device, an electrolyte solution is mainly used as the nonaqueous electrolyte, and thus a degree of freedom is high for a deposition site of the lithium metal, and current tends to concentrate on a site where the lithium metal is likely to be deposited in accordance with nonuniformity of the deposition site. As a result, growth of dendrite is promoted on the surface of the negative electrode at the time of charging. This dendrite is likely to be electrically isolated by dissolving lithium metal on the surface of the negative electrode at the time of subsequent discharge. Since the electrically isolated lithium metal cannot contribute to charge-discharge, the coulombic efficiency of the nonaqueous electrolyte energy storage device decreases. On the other hand, the nonaqueous electrolyte energy storage device can suppress deposition of dendrite by the negative electrode containing a lithium alloy containing gold. When the negative electrode substrate is coated with a coating layer containing gold as a main component, a lithium alloy containing gold is appropriately formed on the coating layer, and as a result, deposition of dendrite can be further suppressed. Therefore, it is considered that since electrical isolation of dendrite is suppressed, the nonaqueous electrolyte energy storage device can improve the coulombic efficiency. Here, the “main component” means a component having the highest content, and refers to a component containing 50 mass% or more relative to the total mass.

In the nonaqueous electrolyte energy storage device, the ratio of the total molar amount of gold contained in the coating layer to the total molar amount of lithium contained in the negative electrode and the positive electrode is preferably 0.4 or less. When the ratio of the total molar amount of gold to the total molar amount of lithium is 0.4 or less, excessive formation of a lithium alloy containing gold in the coating layer due to an alloying reaction of gold and lithium is suppressed, so that the coulombic efficiency can be further improved.

The negative electrode substrate preferably includes a lithium metal layer directly or indirectly stacked on the surface of the metal foil. Since the negative electrode substrate includes the lithium metal layer directly or indirectly stacked on the surface of the metal foil, the amount of electricity corresponding to lithium that cannot contribute to charge-discharge due to electrical isolation of dendrite can be compensated by the lithium metal layer. Therefore, the coulombic efficiency can be further improved. In addition, even when a positive active material not containing lithium first is used for the positive electrode, it is possible to exhibit a good function as a nonaqueous electrolyte energy storage device.

The average thickness of the lithium metal layer is preferably 1 μm or more and 300 μm or less. When the average thickness of the lithium metal layer is 1 μm or more, good charge-discharge cycle performance can be exhibited. Also, when the average thickness of the lithium metal layer is 300 μm or less, the mass of the nonaqueous electrolyte energy storage device is reduced, and the energy density can be improved.

Another aspect of the present invention is an energy storage apparatus including two or more nonaqueous electrolyte energy storage devices, and one or more nonaqueous electrolyte energy storage devices according to one aspect of the present invention.

Hereinafter, the nonaqueous electrolyte energy storage device and an energy storage device according to an embodiment of the present invention will be described in detail. The names of the respective constituent members (respective constituent elements) used in the respective embodiments may be different from the names of the respective constituent members (respective constituent elements) used in the background art.

### <Nonaqueous Electrolyte Energy Storage Device>

The nonaqueous electrolyte energy storage device includes a negative electrode containing a lithium alloy containing gold, and lithium metal, a positive electrode, and a nonaqueous electrolyte. Hereinafter, a nonaqueous electrolyte secondary battery will be described as an example of a nonaqueous electrolyte energy storage device. The positive electrode and the negative electrode usually form an electrode assembly in which the positive electrode and the negative electrode are alternately superposed by being stacked or wound with a separator interposed therebetween. The electrode assembly is housed in a battery case, and the battery case is filled with the nonaqueous electrolyte. The nonaqueous electrolyte is interposed between the positive electrode and the negative electrode. As the battery case, a known metal case, a resin case or the like, which is usually used as a case of a nonaqueous electrolyte secondary battery, can be used.

The nonaqueous electrolyte energy storage device may have a form in which the negative electrode does not contain lithium metal first, or may have a form in which the negative electrode contains lithium metal first. In addition, the negative electrode may be in a form not containing a lithium alloy containing gold first, or may be in a form containing a lithium alloy containing gold first. A nonaqueous electrolyte energy storage device in which a negative electrode does not contain lithium metal first will be described in a first embodiment, and a nonaqueous electrolyte energy storage device in which a negative electrode contains lithium metal first will be described in a second embodiment.

### First Embodiment

A negative electrode of a nonaqueous electrolyte energy storage device according to a first embodiment of the present invention includes a negative electrode substrate including a metal foil and a coating layer coating the negative electrode substrate, and does not contain lithium metal first. In addition, the positive electrode of the nonaqueous electrolyte energy storage device of the present embodiment contains a positive active material containing lithium first.

[Negative electrode]

The negative electrode of the nonaqueous electrolyte energy storage device according to the first embodiment contains a lithium alloy containing gold, and lithium metal. Also, the negative electrode includes a negative electrode substrate including a metal foil, and a coating layer containing gold as a main component. The negative electrode of the present embodiment does not contain lithium metal first, but lithium ions are supplied from the positive active material containing lithium first by initial charge, and as a result, the negative electrode contains lithium metal. When the negative electrode does not contain a lithium alloy containing gold first, the lithium alloy containing gold is appropriately formed in the coating layer by an alloying reaction of the lithium metal, and gold as the main component of the coating layer, and as a result, the negative electrode contains a lithium alloy containing gold. This makes it possible to suppress deposition of dendrite. Therefore, by suppressing electrical isolation of dendrite, the nonaqueous electrolyte energy storage device can improve coulombic efficiency.

In the nonaqueous electrolyte energy storage device, the upper limit of the ratio of the total molar amount of gold contained in the coating layer to the total molar amount of lithium contained in the negative electrode and the positive electrode is preferably 0.4, more preferably 0.1, still more preferably 0.05. When the ratio of the total molar amount of gold to the total molar amount of lithium is equal to or lower than the above upper limit, excessive formation of a lithium alloy containing gold in the coating layer due to an alloying reaction of gold and lithium is suppressed, so that the coulombic efficiency can be further improved. Meanwhile, the lower limit of the ratio of the total molar amount of gold to the total molar amount of lithium is preferably 0.00001, more preferably 0.0001. When the ratio of the total molar amount of gold to the total molar amount of lithium is equal to or greater than the above lower limit, a lithium alloy containing gold including an appropriate composition is formed in the coating layer by an alloying reaction of gold and lithium, so that deposition of dendrite can be suppressed and the coulombic efficiency can be further improved. Here, the “total molar amount of lithium contained in the negative electrode and the positive electrode” refers to a total molar amount of lithium present in the negative active material and the positive active material in the nonaqueous electrolyte energy storage device, and does not contain lithium contained in the nonaqueous electrolyte. Also, the “total molar amount of gold” is the total number of moles of gold derived from the coating layer.

### (Negative Electrode Substrate)

The negative electrode substrate has conductivity, and includes a metal foil. The metal foil contains copper, nickel, or stainless steel as a main component. Moreover, these alloys may be used for the metal foil. Among these metals and alloys, copper or a copper alloy is preferable. The negative electrode substrate is preferably a copper foil or a copper alloy foil. Examples of the copper foil include a rolled copper foil and an electrolytic copper foil. To have “conductivity” means that the volume resistivity measured in conformity with JIS-H0505 (1975) is 1×10⁷ Ω·cm or less, and to be “non-conductive” means that the volume resistivity is more than 1×10⁷ Ω·cm.

The average thickness of the metal foil is preferably 2 μm or more and 35 μm or less, more preferably 3 μm or more and 30 μm or less, still more preferably 4 μm or more and 25 μm or less, particularly preferably 5 μm or more and 20 μm or less. By setting the average thickness of the metal foil to the above range, it is possible to enhance the energy density per volume of the nonaqueous electrolyte energy storage device while increasing the strength of the metal foil. Here, the “average thickness of the metal foil” refers to a value obtained by dividing a cutout mass in cutout of a metal foil having a predetermined area by a true density and a cutout area of the metal foil. The same applies to a positive electrode substrate and a lithium metal layer described later.

(Coating Layer)

The coating layer contains gold as a main component. The coating layer may contain silver, copper, platinum, aluminum, or the like as other components other than gold. The lower limit of the content of gold in the coating layer is preferably 50% by mass, more preferably 90% by mass.

The lower limit of the average thickness of the coating layer is preferably 1 nm, more preferably 5 nm, still more preferably 15 nm. Meanwhile, the upper limit of the average thickness of the coating layer is preferably 1000 nm, more preferably 800 nm, still more preferably 500 nm, further more preferably 200 nm, particularly preferably 150 nm. By setting the average thickness of the coating layer to the above range, a lithium alloy including an appropriate composition is formed in the coating layer by an alloying reaction of gold and lithium, so that deposition of dendrite can be suppressed and the coulombic efficiency can be further improved.

### [Positive Electrode]

The positive electrode includes a positive electrode substrate and a positive active material layer. The positive active material layer contains a positive active material. The positive active material layer is stacked along at least one surface of the positive electrode substrate directly or with an intermediate layer interposed therebetween.

The positive electrode substrate has conductivity. As the material of the substrate, metals such as aluminum, titanium, tantalum, and stainless steel, or alloys thereof are used. Among these, aluminum and aluminum alloys are preferable from the viewpoint of the balance among electric potential resistance, high conductivity, and cost. Examples of the form of the positive electrode substrate include a foil and a vapor deposited film, and a foil is preferable from the viewpoint of cost. More specifically, an aluminum foil is preferable as the positive electrode substrate. Examples of the aluminum or aluminum alloy include A1085 and A3003 prescribed in JIS-H4000 (2014).

The average thickness of the positive electrode substrate is preferably 3 μm or more and 50 μm or less, more preferably 5 μm or more and 40 μm or less, still more preferably 8 μm or more and 30 μm or less, and particularly preferably 10 μm or more and 25 μm or less. By setting the average thickness of the positive electrode substrate to the above range, it is possible to enhance the energy density per volume of the nonaqueous electrolyte energy storage device while increasing the strength of the positive electrode substrate.

The positive active material layer is formed of a so-called positive composite containing a positive active material. Also, the positive composite forming the positive active material layer may contain optional components such as a conductive agent, a binder, a thickener, and a filler and the like as necessary.

In the first embodiment, the positive active material contains lithium, and a material capable of storing and releasing lithium ions is used. The positive active material can be appropriately selected from known positive active materials, and examples thereof include lithium-transition metal composite oxides having an α-NaFeO₂-type crystal structure, lithium-transition metal composite oxides having a spinel-type crystal structure, and polyanion compounds. Examples of the lithium transition metal composite oxide having an α-NaFeO₂ type crystal structure include Li[LiₓNi₁₋ₓ]O₂ (0≤x<0.5), Li[LiₓNi_{y} Co_{(1-x-y)}]O₂ (0≤x<0.5, 0<y<1), Li[LiₓCo₍₁₋ₓ₎]O₂(0≤x<0.5), Li[LiₓNi_{y}Mn_{(1-x-y)}]O₂(0≤x<0.5,0<y<1), Li[LiₓNi_{y}Mn_{β}Co_{(1-x-y-β)}]O₂(0≤x<0.5, 0<y, 0<β, 0.5<y+β<1), and Li[LiₓNi_{y}Co_{β}Al_{(1-x-y-β)}]O₂(0≤x<0.5, 0<y, 0<β, 0.5<y+β<1). Examples of the lithium-transition metal composite oxides having a spinel-type crystal structure include LiₓMn₂O₄ and LiₓNi_{y}Mn_{(2-y)}O₄. Examples of the polyanion compounds include LiFePO₄, LiMnPO₄, LiNiPO₄, LiCoPO₄, Li₃V₂(PO₄)₃, Li₂MnSiO₄, and Li₂CoPO₄F. The surfaces of these materials may be coated with other materials. Some of atoms or polyanions in these materials may be substituted with atoms, or anion species composed of other elements. In the positive active material layer, one of these materials may be used singly or two or more of these materials may be used in mixture. In the positive active material layer, one of these compounds may be used singly, or two or more thereof may be used in mixture.

The content of the positive active material in the positive active material layer is not particularly limited, but the lower limit thereof is preferably 50% by mass, more preferably 80% by mass, still more preferably 90% by mass. Meanwhile, the upper limit of this content is preferably 99% by mass, more preferably 98% by mass.

The conductive agent is not particularly limited so long as it is a material having conductivity. Examples of such a conductive agent include carbonaceous materials; metals; and conductive ceramics. Examples of carbonaceous materials include graphite and carbon black. Examples of the type of the carbon black include furnace black, acetylene black, and ketjen black. Among these, carbonaceous materials are preferable from the viewpoint of conductivity and coatability. In particular, acetylene black and ketjen black are preferable. Examples of the shape of the conductive agent include a powder shape, a sheet shape, and a fibrous shape.

The content of the conductive agent in the positive active material layer is preferably 1% by mass or more and 20% by mass or less, more preferably 2% by mass or more and 15% by mass or less.

Examples of the binder include: thermoplastic resins such as fluororesin (polytetrafluoroethylene (PTFE), polyvinylidene fluoride (PVDF), etc.), polyethylene, polypropylene, and polyimide; elastomers such as ethylene-propylene-diene rubber (EPDM), sulfonated EPDM, styrene-butadiene rubber (SBR), and fluororubber; and polysaccharide polymers.

When the binder is used, the content of the binder in the positive active material layer is preferably 0.5% by mass or more and 15% by mass or less, more preferably 1% by mass or more and 10% by mass or less.

Examples of the thickener mentioned above include polysaccharide polymers such as carboxymethylcellulose (CMC) and methylcellulose. Also, when the thickener includes a functional group that is reactive with lithium, it is preferable to deactivate this functional group by methylation and the like in advance.

When a thickener is used, the ratio of the thickener to the entire positive active material layer can be about 8% by mass or less, and is preferably typically about 5.0% by mass or less.

The filler is not particularly limited. Examples of the filler include polyolefins such as polypropylene and polyethylene, inorganic oxides such as silicon dioxide, aluminum oxide, titanium dioxide, calcium oxide, strontium oxide, barium oxide, magnesium oxide and aluminosilicate, hydroxides such as magnesium hydroxide, calcium hydroxide and aluminum hydroxide, carbonates such as calcium carbonate, hardly soluble ionic crystals of calcium fluoride, barium fluoride, barium sulfate and the like, nitrides such as aluminum nitride and silicon nitride, and substances derived from mineral resources, such as talc, montmorillonite, boehmite, zeolite, apatite, kaolin, mullite, spinel, olivine, sericite, bentonite and mica, and artificial products thereof.

When a filler is used, the ratio of the filler to the entire positive active material layer can be about 8.0% by mass or less, and is preferably typically about 5.0% by mass or less.

The intermediate layer is a coating layer on the surface of the positive electrode substrate, and contains conductive particles such as carbon particles to decrease contact resistance between the positive electrode substrate and the positive active material layer. The configuration of the intermediate layer is not particularly limited, and the intermediate layer can be formed of, for example, a composition containing a resin binder and conductive particles.

The positive active material layer may contain a typical nonmetal element such as B, N, P, F, Cl, Br, or I, a typical metal element such as Li, Na, Mg, Al, K, Ca, Zn, Ga, Ge, Sn, Sr, and Ba or a transition metal element such as Sc, Ti, V, Cr, Mn, Fe, Co, Ni, Cu, Mo, Zr, Nb, or W as a component other than the positive active material, the conductive agent, the binder, the thickener, and the filler.

### [Separator]

As the separator, for example, a woven fabric, a nonwoven fabric, a porous resin film, and the like are used. Among these, a porous resin film is preferable from the viewpoint of strength, and a nonwoven fabric is preferable from the viewpoint of liquid retaining property of the nonaqueous electrolyte. As a main component of the separator, for example, a polyolefin such as polyethylene or polypropylene is preferable from the viewpoint of strength, and for example, polyimide or aramid is preferable from the viewpoint of resistance to oxidative decomposition. These resins may be composited.

It is to be noted that an inorganic layer may be stacked between the separator and the positive electrode or the negative electrode. This inorganic layer is a porous layer, which is also called a heat resistant layer and the like. In addition, a separator with an inorganic layer formed on one or both surfaces of the porous resin film can also be used. The inorganic layer is typically composed of inorganic particles and a binder and may contain other components.

### [Nonaqueous Electrolyte]

As the nonaqueous electrolyte, a known nonaqueous electrolyte normally used for a general nonaqueous electrolyte energy storage device, except for an inorganic solid electrolyte, can be used. The nonaqueous electrolyte contains a nonaqueous solvent and an electrolyte salt dissolved in the nonaqueous solvent. Also, as the nonaqueous electrolyte, a salt that is melted at normal temperature, ionic liquid, a polymer solid electrolyte, a gel electrolyte or the like can also be used. As described above, the nonaqueous electrolyte energy storage device solves the problem in the case of using a nonaqueous electrolyte in which the lithium ion transference number in the nonaqueous electrolyte is not 1 (for example, about 0.4), the degree of freedom for the deposition site of lithium metal is high, and dendrite is easily developed. Therefore, a nonaqueous electrolyte energy storage device using an inorganic solid electrolyte having a lithium ion transference number of 1 does not belong to the technical scope of the present invention.

As the nonaqueous solvent, it is possible to use a known nonaqueous solvent typically used as a nonaqueous solvent of a general nonaqueous electrolyte for an energy storage device. Examples of the nonaqueous solvent include cyclic carbonate, chain carbonate, ester, ether, amide, sulfone, lactone, and nitrile. Among these, it is preferable to use at least the cyclic carbonate or the chain carbonate, and it is more preferable use the cyclic carbonate and the chain carbonate in combination. When the cyclic carbonate and the chain carbonate are used in combination, the volume ratio of the cyclic carbonate to the chain carbonate (cyclic carbonate : chain carbonate) is not particularly limited but is preferably from 5:95 to 50:50, for example.

Examples of the cyclic carbonate include ethylene carbonate (EC), propylene carbonate (PC), butylene carbonate (BC), vinylene carbonate (VC), vinylethylene carbonate (VEC), chloroethylene carbonate, fluoroethylene carbonate (FEC), difluoroethylene carbonate (DFEC), fluoropropylene carbonate, fluorobutylene carbonate, styrene carbonate, catechol carbonate, 1-phenylvinylene carbonate, and 1,2-diphenylvinylene carbonate, and among these, EC or FEC is preferable.

Examples of the chain carbonate include diethyl carbonate (DEC), dimethyl carbonate (DMC), ethyl carbonate (EMC), diphenyl carbonate, trifluoroethyl methyl carbonate (TFEMC), and bis(trifluoroethyl) carbonate, and among these, DMC, EMC or TFEMC is preferable.

As the electrolyte salt, it is possible to use a known electrolyte salt typically used as an electrolyte salt of a general nonaqueous electrolyte for an energy storage device. Examples of the electrolyte salt include a lithium salt, a sodium salt, a potassium salt, a magnesium salt, and an onium salt, and a lithium salt is preferable.

Examples of the lithium salt include inorganic lithium salts such as LiPF₆, LiPO₂F₂, LiBF₄, LiClO₄, and LiN(SO₂F)₂, and lithium salts including a hydrocarbon group in which hydrogen is replaced by fluorine, such as LiSO₃CF₃, LiN(SO₂CF₃)₂, LiN(SO₂C₂F₅)₂, LiN(SO₂CF₃)(SO₂C₄F₉), LiC(SO₂CF₃)₃ and LiC(SO₂C₂F₅)₃. Among these salts, an inorganic lithium salt is preferable, and LiPF₆ is more preferable.

The lower limit of the concentration of the electrolyte salt in the nonaqueous electrolyte is preferably 0.1 mol/dm³, more preferably 0.3 mol/dm³, still more preferably 0.5 mol/dm³, particularly preferably 0.7 mol/dm³. Meanwhile, the upper limit is not particularly limited, and is preferably 2.5 mol/dm³, more preferably 2.0 mol/dm³, still more preferably 1.5 mol/dm³.

The nonaqueous electrolyte may contain an additive. Examples of the additive include aromatic compounds such as biphenyl, alkylbiphenyl, terphenyl, partly hydrogenated terphenyl, cyclohexylbenzene, t-butylbenzene, t-amylbenzene, diphenyl ether, and dibenzofuran; partial halides of the aromatic compounds such as 2-fluorobiphenyl, o-cyclohexylfluorobenzene, and p-cyclohexylfluorobenzene; halogenated anisole compounds such as 2,4-difluoroanisole, 2,5-difluoroanisole, 2,6-difluoroanisole, and 3,5-difluoroanisole; succinic anhydride, glutaric anhydride, maleic anhydride, citraconic anhydride, glutaconic anhydride, itaconic anhydride, and cyclohexanedicarboxylic anhydride; ethylene sulfite, propylene sulfite, dimethyl sulfite, dimethyl sulfate, ethylene sulfate, sulfolane, dimethyl sulfone, diethyl sulfone, dimethylsulfoxide, diethyl sulfoxide, tetramethylene sulfoxide, diphenyl sulfide, 4,4′-bis(2,2-dioxo-1,3,2-dioxathiolane), 4-methylsulfonyloxymethyl-2,2-dioxo-1,3,2-dioxathiolane, thioanisole, diphenyl disulfide, dipyridinium disulfide, perfluorooctane, tristrimethylsilyl borate, tristrimethylsilyl phosphate, and tetrakistrimethylsilyl titanate. These additives may be used singly, or two or more thereof may be used in mixture.

The content of the additive contained in the nonaqueous electrolyte is preferably 0.01% by mass or more and 10% by mass or less, more preferably 0.1% by mass or more and 7% by mass or less, further preferably 0.2% by mass or more and 5% by mass or less, and particularly preferably 0.3% by mass or more and 3% by mass or less, with respect to the total nonaqueous electrolyte.

### [Specific Configuration of Nonaqueous Electrolyte Energy Storage Device]

The shape of the energy storage device according to the present embodiment is not particularly limited, and examples thereof include cylindrical batteries, laminated film batteries, prismatic batteries, flat batteries, coin batteries and button batteries.

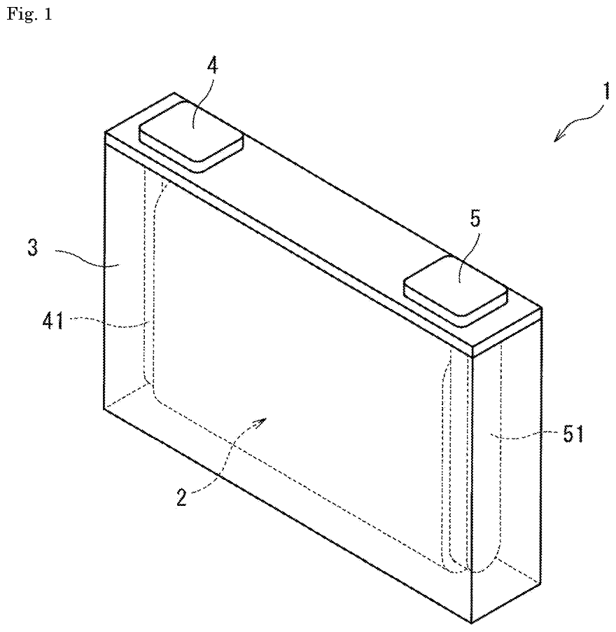

FIG. 1 shows a prismatic nonaqueous electrolyte secondary battery 1 as an example of the nonaqueous electrolyte energy storage device. FIG. 1 is a view showing the inside of a battery case in a perspective manner. An electrode assembly 2 including a positive electrode and a negative electrode which are wound with a separator interposed therebetween is housed in a prismatic battery case 3. The positive electrode is electrically connected to a positive electrode terminal 4 via a positive current collector 41. The negative electrode is electrically connected to a negative electrode terminal 5 via a negative current collector 51.

According to the nonaqueous electrolyte energy storage device according to the first embodiment of the present invention, deposition of dendrite can be suppressed. Therefore, by suppressing electrical isolation of dendrite, the nonaqueous electrolyte energy storage device can improve coulombic efficiency when the negative electrode contains lithium metal.

### Second Embodiment

A negative electrode of a nonaqueous electrolyte energy storage device according to a second embodiment of the present invention includes a negative electrode substrate including a metal foil and a coating layer coating the negative electrode substrate, and first contains lithium metal. In the nonaqueous electrolyte energy storage device according to the second embodiment, the negative electrode substrate includes a lithium metal layer directly or indirectly stacked on a surface of the metal foil. That is, in the nonaqueous electrolyte energy storage device according to the second embodiment, the negative electrode substrate includes a metal foil and a lithium metal layer. As described above, the nonaqueous electrolyte energy storage device according to the second embodiment is different from the first embodiment in that the negative electrode first contains lithium metal. Therefore, the coating layer is coated on the surface of the lithium metal layer. Since the negative electrode substrate includes the lithium metal layer directly or indirectly stacked on the surface of the metal foil, the amount of lithium included in the negative electrode substrate increases, and as a result, the coulombic efficiency can be further improved. In addition, even when the positive electrode does not contain lithium first, good energy storage device performance can be exhibited.

The lithium metal includes a lithium alloy as well as a simple substance of lithium. Examples of the lithium alloy include lithium-copper alloy and lithium-aluminum alloy. The lithium metal layer can include a lithium metal foil, a vapor-deposited lithium metal layer, or the like.

The lower limit of the average thickness of the lithium metal layer is preferably 1 μm, more preferably 5 μm, still more preferably 10 μm. Meanwhile, the upper limit of the average thickness of the lithium metal layer is preferably 300 μm, more preferably 200 μm, still more preferably 100 μm. By setting the average thickness of the lithium metal layer to the above range, it is possible to achieve both good charge-discharge cycle performance and high energy density of the nonaqueous electrolyte energy storage device.

In the negative electrode substrate of the present embodiment, an alloy layer containing metal (for example, copper) as a component of the metal foil and lithium may be formed between the metal foil (for example, copper foil) and the lithium metal layer.

The positive electrode of the nonaqueous electrolyte energy storage device according to the second embodiment can be appropriately selected from known positive active materials, and a positive active material not containing lithium may be used. Examples of the positive active material in the present embodiment include a chalcogenide and sulfur, in addition to the positive active material containing lithium described in the first embodiment. Examples of the chalcogenides include titanium disulfide, molybdenum disulfide, and molybdenum dioxide.

Other configurations of the nonaqueous electrolyte energy storage device according to the second embodiment are the same as those of the nonaqueous electrolyte energy storage device according to the first embodiment.

According to the nonaqueous electrolyte energy storage device of the second embodiment, since the negative electrode substrate includes the lithium metal layer directly or indirectly stacked on the surface of the metal foil, the amount of lithium included in the negative electrode substrate increases, and as a result, in the nonaqueous electrolyte energy storage device, the coulombic efficiency can be further improved when the negative electrode contains lithium metal.

### <Method for Fabricating Nonaqueous Electrolyte Energy Storage Device>

The method of fabricating the nonaqueous electrolyte energy storage device according to the present embodiment can be appropriately selected from known methods. The fabrication method includes, for example, a step of preparing an electrode assembly, a step of preparing a nonaqueous electrolyte, and a step of housing the electrode assembly and the nonaqueous electrolyte in a battery case. The step of preparing an electrode assembly includes a step of preparing a positive electrode and a negative electrode and a step of forming an electrode assembly by stacking or winding the positive electrode and the negative electrode with a separator interposed therebetween.

In the method for fabricating a nonaqueous electrolyte energy storage device according to the first embodiment, in the step of preparing a negative electrode, the coating layer is formed by performing sputtering, vapor deposition, plating, coating or the like on the surface of the metal foil as the negative electrode substrate.

In the method for fabricating a nonaqueous electrolyte energy storage device according to the second embodiment, in the step of preparing a negative electrode, the lithium metal layer is stacked on the surface of the metal foil to form a negative electrode substrate. The stack of the metal foil and the lithium metal layer can be performed by pressing or the like. Next, a coating layer is formed on the surface of the lithium metal layer by performing sputtering, vapor deposition, plating, coating, or the like on the material of the coating layer.

The method of housing the nonaqueous electrolyte in a battery case can be appropriately selected from known methods. For example, when a liquid nonaqueous electrolyte (also referred to as “electrolyte solution”) is used, the electrolyte solution may be injected through an injection port formed in the battery case and then the injection port may be sealed. The details of other elements constituting the nonaqueous electrolyte energy storage device obtained by the fabrication method are as described above.

As described above, in the nonaqueous electrolyte energy storage device according to the first embodiment, the lithium alloy containing gold and the lithium metal are contained in the negative electrode by supplying lithium ions from the positive active material at the time of initial charge.

### Other Embodiments

The nonaqueous electrolyte energy storage device according to the present invention is not limited to the embodiment described above, and various changes may be made without departing from the gist of the present invention. For example, the configuration according to one embodiment can be added to the configuration according to another embodiment, or a part of the configuration according to one embodiment can be replaced with the configuration according to another embodiment or a well-known technique. Furthermore, a part of the configuration according to one embodiment can be removed. In addition, a well-known technique can be added to the configuration according to one embodiment.

In the above embodiment, although the case where the nonaqueous electrolyte energy storage device is used as a nonaqueous electrolyte secondary battery (for example, lithium secondary battery) that can be charged and discharged has been described, the type, shape, size, capacity, and the like of the nonaqueous electrolyte energy storage device are arbitrary. The nonaqueous electrolyte energy storage device according to the present invention can also be applied to capacitors such as various nonaqueous electrolyte secondary batteries, electric double layer capacitors, and lithium ion capacitors.

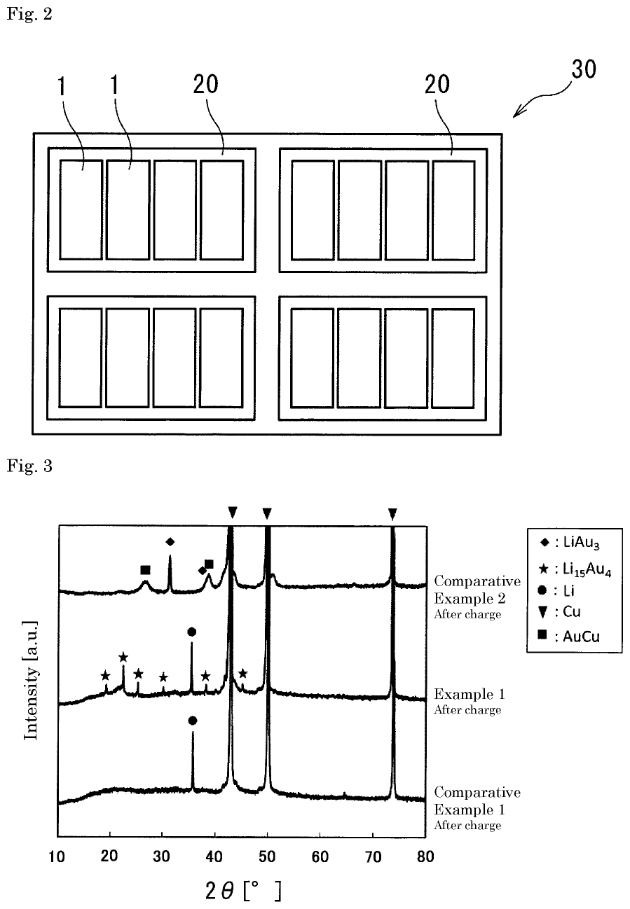

The present invention can also be realized as an energy storage apparatus including a plurality of the nonaqueous electrolyte energy storage devices. An assembled battery can be configured using one or a plurality of nonaqueous electrolyte energy storage devices (cells) of the present invention, and an energy storage apparatus can be configured using the assembled battery. The energy storage apparatus according to an embodiment of the present invention includes two or more nonaqueous electrolyte energy storage devices and one or more nonaqueous electrolyte energy storage devices according to an embodiment of the present invention (hereinafter referred to as “third embodiment”). The technique according to an embodiment of the present invention may be applied to at least one nonaqueous electrolyte energy storage device included in the energy storage apparatus according to the third embodiment, one nonaqueous electrolyte energy storage device according to an embodiment of the present invention may be provided, and one or more nonaqueous electrolyte energy storage devices not according to an embodiment of the present invention may be provided, or two or more nonaqueous electrolyte energy storage devices according to an embodiment of the present invention may be provided. FIG. 2 shows an embodiment of the energy storage apparatus according to the third embodiment. In FIG. 2, an energy storage apparatus 30 according to the third embodiment includes a plurality of electrically connected energy storage units 20. Each of the energy storage units 20 includes a plurality of the electrically connected nonaqueous electrolyte energy storage devices 1. The energy storage apparatus can be used as a power source for a motor vehicle, such as an electric vehicle (EV), a hybrid vehicle (HEV), or a plug-in hybrid vehicle (PHEV). The energy storage apparatus can be used for various power source apparatuses such engine starting power source apparatuses, auxiliary power source apparatuses, and uninterruptible power systems (UPSs).

The energy storage apparatus 30 may include a bus bar (not illustrated) that electrically connects two or more nonaqueous electrolyte energy storage devices 1 to each other and a bus bar (not illustrated) that electrically connects two or more energy storage units 20 to each other. The energy storage unit 20 or the energy storage apparatus 30 may include a state monitor (not illustrated) that monitors the state of one or more nonaqueous electrolyte energy storage devices.

### EXAMPLES

Hereinafter, the present invention will be described in more detail with reference to examples, but the present invention is not limited to the following examples.

### Examples 1 to 7 and Comparative Examples 1 to 6

### Fabrication of Negative Electrode

As a metal foil constituting at least a part of the negative electrode substrate, a copper foil with an average thickness of 10 μm was prepared. In Examples 1 to 4 and Comparative Examples 2 to 5, a coating layer shown in Table 1 was formed on one surface of the copper foil. In Examples 5 to 7 and Comparative Example 6, a lithium metal layer constituting a negative electrode substrate was formed by stacking lithium metal with an average thickness shown in Table 2 on the copper foil, and in Examples 5 to 7, a coating layer shown in Table 2 was formed on the surface of the lithium metal layer. Each of the negative electrodes thus obtained has a rectangular shape with a width of 30 mm and a length of 40 mm.

### Formation of Coating Layer

When the material of the coating layer was gold (Au) or tin (Sn), the coating layer was formed on the surface of the negative electrode substrate by the following procedure using sputtering method. MAGNETRON SPUTTERING DEVICE (JUC-5000) manufactured by JEOL was used as a sputtering apparatus, and Au or Sn with a purity of 99.99% was used as a target. The height from the surface of the negative electrode substrate to the target was set to 25 mm, the coating current was set to 10 mA, and gold or tin was sputtered on the surface of the negative electrode substrate. Also, the average thickness of the coating layer was adjusted by adjusting the coating time. All the above operations were performed in a dry room.

When the material of the coating layer was silver (Ag) or zinc oxide (ZnO), the coating layer was formed on the surface of the negative electrode substrate by the following procedure using coating method. DOTITE D550 manufactured by Fujikura Kasei Co., Ltd. was prepared as a material of the silver. As a material of the zinc oxide, zinc oxide particles with a particle size of 20 nm were prepared. A coating layer paste containing N-methylpyrrolidone as a dispersion medium in a mass ratio of the silver or zinc oxide material:polyvinylidene fluoride=95 : 5 was prepared, and applied to the surface of the negative electrode substrate using an applicator. Thereafter, the dispersion medium was volatilized by drying at 100° C. for 30 minutes. All the above operations were performed in a dry room.

### Fabrication of Positive Electrode

As a positive active material, a lithium-transition metal composite oxide, which had an α-NaFeO₂-type crystal structure and was represented by Li_{1+α}Me_{1-α}O₂ (Me was a transition metal), was used. In this regard, the molar ratio Li/Me of Li to Me was 1.33, and Me was composed of Ni and Mn and was contained at a molar ratio of Ni:Mn=0.33:0.67.

A positive electrode paste, which contained the positive active material, acetylene black (AB) as a conductive agent, and polyvinylidene fluoride (PVDF) as a binder at a mass ratio of 92.5:4.5:3.0, was prepared using N-methylpyrrolidone (NMP) as a dispersion medium. The positive electrode paste was applied to one surface of an aluminum foil with an average thickness of 15 μm as a positive electrode substrate, and dried, and the resultant was pressed and cut to fabricate a positive electrode including a positive active material layer disposed in a rectangular shape having a width of 30 mm and a length of 40 mm.

### Preparation of Nonaqueous Electrolyte

Fluoroethylene carbonate (FEC) and 2,2,2-trifluoroethyl methyl carbonate (TFEMC) were used as nonaqueous solvents. Then, LiPF₆ was dissolved at a concentration of 1 mol/dm³ in a mixed solvent mixed at a volume ratio of FEC:TFEMC=30:70 to obtain a nonaqueous electrolyte.

### Fabrication of Nonaqueous Electrolyte Energy Storage Device

The positive electrode and the negative electrode were stacked with the separator interposed therebetween, thereby fabricating an electrode assembly. The electrode assembly was housed in a case, then the nonaqueous electrolyte was injected into the inside of the case, and then an opening of the case was sealed by heat sealing to obtain a nonaqueous electrolyte energy storage device (secondary battery) according to Example 1 as a pouched cell.

### Initial Charge-Discharge

The obtained nonaqueous electrolyte energy storage devices were initially charged and discharged for 2 cycles at 25° C. under the following conditions. As initial discharge, constant current constant voltage charge was performed at a charge current of 0.1 C and an end-of-charge voltage of 4.6 V. With regard to the charge termination conditions, charge was performed until the charge current reached 0.05 C. Thereafter, a pause time of 10 minutes was provided. Thereafter, as initial discharge, constant current discharge was performed at a discharge current of 0.1 C and an end-of-discharge voltage of 2.0 V, and then a pause time of 10 minutes was provided. Charge-discharge in the second cycle was performed under the same conditions as in the initial charge-discharge, and the discharge capacity (mAh/g) per mass of the positive active material was calculated based on the discharge capacity in the second cycle, and defined as “positive electrode discharge capacity at the second cycle”. The current value at 1 C was set to 270 mA/g per mass of the positive active material.

### Coulombic Efficiency in Second Cycle

The percentage of the discharge capacity in the second cycle to the amount of charge in the second cycle in the initial charge-discharge was determined as “coulombic efficiency (%) in the second cycle”.

### Positive Electrode Discharge Capacity after Charge-Discharge Cycle Test

The nonaqueous electrolyte energy storage devices according to Examples 5 to 7 and Comparative Example 6 after the initial charge-discharge were further subjected to the following charge-discharge cycle test. At 25° C., constant current constant voltage charge was performed at a charge current of 0.2 C and an end-of-charge voltage of 4.6 V. With regard to the charge termination conditions, charge was performed until the charge current reached 0.05 C. Thereafter, a pause time of 10 minutes was provided. Thereafter, constant current discharge was performed at a discharge current of 0.1 C and an end-of-discharge voltage of 2.0 V, and then a pause time of 10 minutes was provided. This charge-discharge was repeated 120 cycles, and the discharge capacity (mAh/g) per mass of the positive active material was calculated based on the discharge capacity in the 120th cycle, and defined as the “positive electrode discharge capacity after 120 cycles”.

### Evaluation of Dendrite Deposition after Initial Charge)

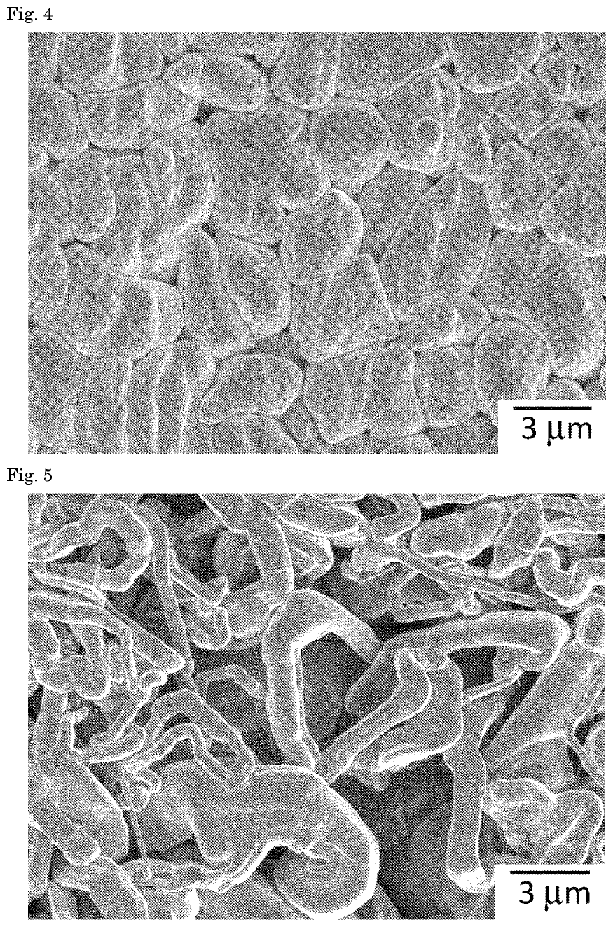

The presence or absence of deposition of dendrite on the surface of the negative electrode after the initial charge was visually determined. Also, the surface of the negative electrode after the initial charge was observed using JSM-7001F manufactured by JEOL Ltd. as a field emission scanning electron microscope (FE-SEM). An acceleration voltage was set to 1 kV. FIG. 4 shows an image by scanning electron microscope (SEM) observation after the initial charge of Example 1, and FIG. 5 shows an image by SEM observation after the initial charge of Comparative Example 1.

### Amount of Lithium Contained in Positive Electrode

The amount (mmol) of lithium contained in the positive electrode was determined by calculating the molar amount of all lithium contained in the positive active material contained in the positive active material layer of 12 cm².

### Amount of Lithium to be Alloyed with Gold

The amount (mmol) of lithium to be alloyed with gold was determined by calculating the molar amount of alloyed lithium assuming that all gold contained in the coating layer of the negative electrode of 12 cm² forms Liₗ₅Au₄.

Identification of Negative Electrode Phase after Initial Charge

The negative electrode after the initial charge according to each of the above Examples and Comparative Examples were subjected to X-ray diffraction measurement using an X-ray diffractometer (manufactured by Rigaku Corporation, model name: MiniFlex II). Here, the X-ray source was CuKa, the acceleration voltage and current were 30 kV and 15 mA, respectively, a sampling width was 0.01 deg, a scanning time was 15 minutes (scanning speed was 5.0), a divergence slit width was 0.625 deg, a light receiving slit width was open, and a scattering slit was 8.0 mm. A sample was enclosed in an argon atmosphere, and a sample stage was airtightly sealed by an O-ring.

FIG. 3 shows X-ray diffraction (XRD) diagrams of the negative electrodes of Example 1, Comparative Example 1, and Comparative Example 2 in the range of 2θ=10° to 80°.

Tables 1 and 2 show results of the amount of lithium contained in the positive electrode, the amount of lithium to be alloyed with gold, the ratio of the total molar amount of gold contained in the coating layer to the total molar amount of lithium contained in the negative electrode and the positive electrode, the coulombic efficiency in the second cycle, the positive electrode discharge capacity in the second cycle in the initial charge-discharge, the positive electrode discharge capacity in the 120th cycle after the charge-discharge cycle test, the evaluation of dendrite deposition after the initial charge, and the like. Table 1 shows results of Examples 1 to 4 and Comparative Examples 1 to 7, and Table 2 shows results of Examples 5 to 7 and Comparative Example 6.

Here, the “Au/Li molar ratio in energy storage device system” in Tables 1 and 2 is a ratio of the total molar amount of gold contained in the coating layer to the total molar amount of lithium contained in the negative electrode and the positive electrode. Further, in Examples 1 to 4 and Comparative Example 2, the total molar amount of lithium contained in the negative electrode and the positive electrode is the “amount of lithium contained in the positive electrode”, and in Examples 5 to 7, the total molar amount of lithium is a sum of the “amount of lithium contained in the positive electrode” and the molar amount corresponding to the lithium metal layer constituting the negative electrode substrate. Incidentally, the amount of lithium contained in the nonaqueous electrolyte is not included here.

TABLE 1

| | | | | | Positive | | |
|---|---|---|---|---|---|---|---|
| | | | | | active | Amount of | |
| | | Lithium | | Coating | material | lithium | Amount of |
| | | metal layer | | material | layer | contained in | lithium to be |
| | Negative | average | | average | application | positive | alloyed |
| | electrode | thickness | Coating | thickness | mass | electrode | with gold |
| | substrate | [μm] | material | [nm] | [mg/cm²] | [mmol] | [mmol] |
| Comparative | Cu | — | — | — | 24.9 | 3.57 | — |
| Example 1 | | | | | | | |
| Example 1 | Cu | — | Au | 1 | 24.9 | 3.57 | 0.0004 |
| Example 2 | Cu | — | Au | 15 | 24.9 | 3.57 | 0.0066 |
| Example 3 | Cu | — | Au | 348 | 26.5 | 3.79 | 0.1536 |
| Example 4 | Cu | — | Au | 684 | 4.0 | 0.58 | 0.3019 |
| Comparative | Cu | — | Au | 887 | 1.5 | 0.21 | 0.3915 |
| Example 2 | | | | | | | |
| Comparative | Cu | — | Sn | 50 | 25.0 | 3.58 | — |
| Example 3 | | | | | | | |
| Comparative | Cu | — | Ag | 9000 | 24.1 | 3.46 | — |
| Example 4 | | | | | | | |
| Comparative | Cu | — | ZnO | 9000 | 24.9 | 3.57 | — |
| Example 5 | | | | | | | |

| | | Au/Li | Evaluation | | |
|---|---|---|---|---|---|
| | | molar | | Positive | |
| | Negative | ratio in | | electrode | Presence or |
| | electrode | energy | Coulombic | discharge | absence of |
| | phase after | storage | efficiency in | capacity in | deposition |
| | initial | device | second cycle | second cycle | of lithium |
| | charge | system | [%] | [mAh/g] | dendrite |
| Comparative | Li | — | 97.6 | 224 | Present |
| Example 1 | | | | | |
| Example 1 | Li, Li₁₅Au₄ | 0.00003 | 99.2 | 230 | Absent |
| Example 2 | Li, Li₁₅Au₄ | 0.00050 | 100.0 | 236 | Absent |
| Example 3 | Li, Li₁₅Au₄ | 0.01081 | 100.0 | 224 | Absent |
| Example 4 | Li, Li₁₅Au₄ | 0.13901 | 100.0 | 230 | Absent |
| Comparative | AuCu, LiAu₃ | 0.49028 | 0.0 | 0 | Absent |
| Example 2 | | | | | |
| Comparative | Li, Li₁₅Sn₄ | — | 98.0 | 229 | Present |
| Example 3 | | | | | |
| Comparative | Li, LiAg | — | 82.9 | 184 | Absent |
| Example 4 | | | | | |
| Comparative | Li, LiZn | — | 96.2 | 203 | Present |
| Example 5 | | | | | |

TABLE 2

| | | | | | Positive | | |
|---|---|---|---|---|---|---|---|
| | | | | | active | Amount of | |
| | | Lithium | | Coating | material | lithium | Amount of |
| | | metal layer | | material | layer | contained in | lithium to be |
| | Negative | average | | average | application | positive | alloyed with |
| | electrode | thickness | Coating | thickness | mass | electrode | gold |
| | substrate | [μm] | material | [nm] | [mg/cm²] | [mmol] | [mmol] |
| Comparative | Cu foil | 100 | — | — | 25.0 | 3.58 | — |
| Example 6 | | | | | | | |
| Example 5 | Cu foil | 100 | Au | 10 | 25.0 | 3.58 | 0.0044 |
| Example 6 | Cu foil | 100 | Au | 15 | 24.5 | 3.51 | 0.0066 |
| Example 7 | Cu foil | 60 | Au | 15 | 24.1 | 3.46 | 0.0066 |

| | | | Evaluation | | | |
|---|---|---|---|---|---|---|
| | | Au/Li molar | | Positive | Positive | |
| | | ratio in | | electrode | electrode | Presence or |
| | Negative | energy | Coulombic | discharge | discharge | absence of |
| | electrode | storage | efficiency in | capacity in | capacity after | deposition |
| | phase after | device | second cycle | second cycle | 120 cycles | of lithium |
| | initial charge | system | [%] | [mAh/g] | [mAh/g] | dendrite |
| Comparative | Li | — | 100.0 | 234 | 69 | Present |
| Example 6 | | | | | | |
| Example 5 | Li, Li₁₅Au₄ | 0.00010 | 100.0 | 239 | 84 | Absent |
| Example 6 | Li, Li₁₅Au₄ | 0.00010 | 100.0 | 233 | 85 | Absent |
| Example 7 | Li, Li₁₅Au₄ | 0.00020 | 100.0 | 236 | 87 | Absent |

As shown in Table 1, in Examples 1 to 4 in which the negative electrode contains a lithium alloy containing gold, and lithium metal and includes a negative electrode substrate including a metal foil and a coating layer coating the negative electrode substrate and containing gold as a main component, the coulombic efficiency in the second cycle was good.

In addition, as shown in the X-ray diffraction diagram of the negative electrode after the initial charge in FIG. 3, in the negative electrode of Example 1 including a coating layer containing gold as a main component, an XRD pattern of a lithium alloy containing lithium metal and gold was observed after the initial charge. Meanwhile, in the negative electrode of Comparative Example 1 including no coating layer containing gold as a main component, the XRD pattern of the lithium alloy containing gold was not observed, and it was found that the lithium alloy containing gold was not formed. Further, in the negative electrode of Comparative Example 2 in which the coating layer containing gold as a main component was excessively coated and the coulombic efficiency in the second cycle was 0%, the XRD patterns of the copper alloy containing gold and the lithium alloy containing gold were observed after the initial charge. From this, it is considered that in Comparative Example 2, the coating layer containing gold as a main component was excessively coated, so that lithium metal that was reversibly dissolved and deposited was not present, and as a result, charge-discharge could not be performed.

Furthermore, from the evaluation of dendrite deposition in Table 1 and the SEM images of the surface of the negative electrode after the initial charge in Example 1 and Comparative Example 1 shown in FIGS. 4 and 5, it is found that the deposition of dendrite is suppressed by coating the negative electrode substrate with the coating layer containing gold as a main component. From these results, it is considered that in the nonaqueous electrolyte energy storage device, the deposition of dendrite is suppressed in the negative electrode, whereby the coulombic efficiency is improved.

From the results of Comparative Examples 3, 4, and 5 in Table 1, when including the coating layer containing tin, silver, or zinc oxide as a main component, the coulombic efficiency in the second cycle was lower than that in the examples including the coating layer containing gold as a main component. This is presumed as follows. Tin, silver, or zinc oxide undergoes an alloying reaction with lithium metal similarly to gold, and a lithium alloy containing tin, silver, or zinc is formed on the coating layer. Although tin, silver, or zinc oxide has affinity with lithium metal in a state before alloying, it is considered that the lithium alloy has no affinity with lithium metal unlike the lithium alloy containing gold of the examples, and as a result, the coulombic efficiency decreases.

When comparing Examples 5 to 7 and Comparative Example 6 in which the negative electrode substrate had a metal foil and a lithium metal layer shown in Table 2, Examples 5 to 7 including a coating layer containing gold as a main component were also excellent in the positive electrode discharge capacity after 120 cycles in addition to the coulombic efficiency in the second cycle. In Examples 5 to 7, the coulombic efficiency in the 120th cycle was also 100%.

As a result, it was shown that the nonaqueous electrolyte energy storage device can improve coulombic efficiency when the negative electrode contains lithium metal.

### INDUSTRIAL APPLICABILITY

The present invention can be applied to a nonaqueous electrolyte energy storage device and an energy storage apparatus, which are used as a power source for electronic devices such as personal computers and communication terminals, motor vehicles, and the like.

### DESCRIPTION OF REFERENCE SIGNS

1: nonaqueous electrolyte energy storage device
2: electrode assembly
3: battery case
4: positive electrode terminal
41: positive current collector
5: negative electrode terminal
51: negative current collector
20: energy storage unit
30: energy storage apparatus

1. A nonaqueous electrolyte energy storage device comprising:
a negative electrode containing a lithium alloy containing gold, and lithium metal;
a positive electrode; and
a nonaqueous electrolyte;
wherein the negative electrode includes a negative electrode substrate including a metal foil and a coating layer coating the negative electrode substrate,
the metal foil contains copper, nickel, or stainless steel as a main component, and
the coating layer contains gold as a main component.

2. The nonaqueous electrolyte energy storage device according to claim 1, wherein a ratio of a total molar amount of gold contained in the coating layer to a total molar amount of lithium contained in the negative electrode and the positive electrode is 0.4 or less.

3. The nonaqueous electrolyte energy storage device according to claim 1, wherein the negative electrode substrate includes a lithium metal layer directly or indirectly stacked on a surface of the metal foil.

4. The nonaqueous electrolyte energy storage device according to claim 1, wherein the lithium metal layer has an average thickness of 1 μm or more and 300 μm or less.

5. An energy storage apparatus comprising two or more nonaqueous electrolyte energy storage devices, and one or more nonaqueous electrolyte energy storage devices according to claim 1.
